(19) United States
(12) Patent Application Publication
(10) Pub. No.: US 2006/0066207 A1
(43) Pub. Date: Mar. 30, 2006

(54) Color picture tube

(75) Inventors: Norio Shimizu, Ibaraki-shi (JP); Fumiaki Nihei, Ibaraki-shi (JP); Takashi Murai, Ibaraki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/141,677

(22) Filed: May 31, 2005

(30) Foreign Application Priority Data
Aug. 17, 2004 (JP) 2004-237553

(51) Int. Cl. H01J 29/86; H01J 29/92

(52) U.S. Cl. 313/477 R

(57) ABSTRACT

The radius of curvature of an outer surface of a useful portion of a panel is 10,000 mm or more, and a shadow mask is made of a material containing 95% or more of iron. Assuming that a distance (unit: mm) along an X-axis between a center of the panel and a peripheral edge of the useful portion is LH, and a total number of rows of apertures composed of electron beam passage apertures arranged on a straight line substantially parallel to a Y-axis is N, 0.9≦LH/N≦1.0 is satisfied. Furthermore, assuming that a pitch of adjacent rows of apertures is PHC at a center of a perforated region of the shadow mask, PHH at a major axis end of the perforated region, and PHM at a point away from the center of the perforated region by 2/3 of a distance MH between the center of the perforated region and the major axis end along the X-axis, PHM/PHC≦1.2 and PHH/PHC≦1.4 are satisfied. Because of this, a color picture tube can be provided, which has satisfactory visibility, has less degradation in color purity due to doming while having a shadow mask made of an inexpensive material with satisfactory formability, and is excellent in uniformity of brightness.

### BACKGROUND OF THE INVENTION

1. Field of the Invention

The present invention relates to a color picture tube having a shadow mask made of a material containing 95% or more of iron, in which a radius of curvature of a panel outer surface is 10,000 mm or more.

2. Description of Related Art

In general, as shown in FIG. 1, a color picture tube includes an envelope composed of a panel 3 in which a skirt portion 2 is provided on the periphery of a substantially rectangular useful portion 1, and a funnel 4 in a funnel shape connected to the skirt portion 2. A shadow mask 7 having a substantially rectangular perforated region, in which a number of electron beam passage apertures 6 are arranged in vertical and horizontal directions, is placed so as to be opposed to the phosphor screen 5 composed of three-color phosphor layers formed on an inner surface of the useful portion 1 of the panel 3. The shadow mask 7 is held by a mask frame 8 having a substantially rectangular frame shape. A shadow mask structure 9 composed of the shadow mask 7 and the mask frame 8 is supported detachably with respect to the panel 3 with one end of a substantially V-shaped elastic support 15 attached to each corner portion or respectively on short sides and long sides of the mask frame 8, and the other end of the elastic support 15 engaged with a stud pin 16 fixed on an inner wall of the skirt portion 2 of the panel 3. An electron gun 12 emitting three electron beams 11 is housed in a neck 10 of the funnel 4. The three electron beams 11 emitted by the electron gun 12 are deflected by a magnetic field generated by a deflection apparatus 13 mounted on an outer side of the funnel 4, and allowed to scan the phosphor screen 5 in horizontal and vertical directions via the shadow mask 7, thereby displaying a color image.

In general, in order to display an image without any color displacement on the phosphor screen 5 of the color picture tube, the three electron beams 11 passing through the electron beam passage apertures 6 formed in the shadow mask 7 should land correctly on the three-color phosphor layers of the phosphor screen 5 respectively.

For the above purpose, it is necessary to correctly keep an interval (q value) between the inner surface of the useful portion 1 of the panel 3 and the shadow mask 7.

As shown in FIG. 2, the phosphor screen 5 is formed by a light-exposure process of irradiating the inner surface of the panel 3 with light beams from light sources 18R, 18G, and 18B of a light-exposure apparatus, approximated to paths of the three electron beams, using the shadow mask 7 as a mask. In FIG. 2, q represents an interval (q value) between the panel 3 and the shadow mask 7, PH represents an arrangement pitch in a major axis (X-axis) direction of the electron beam passage apertures 6 formed in the shadow mask 7, and D represents an aperture width of each electron beam passage aperture 6 in the major axis (X-axis) direction.

As shown in FIG. 3A, assuming that an interval between a center line of a red (R) phosphor stripe and a center line of a blue (B) phosphor stripe is d and an arrangement pitch of red (R), green (G), and blue (B) three-color phosphor stripes is PHp, a uniform phosphor stripe is obtained by setting the q value so as to satisfy d=⅔ PHp.

However, in the case where the q value is not set correctly, an appropriate relationship between the interval d and the pitch PHp is broken, with the result that the width of black non-light-emitting layers 17 cannot be kept sufficiently as shown in FIGS. 3B and 3C. In this case, when the irradiation position of an electron beam is shifted during the operation of the color picture tube, the electron beam irradiates a phosphor stripe of a color other than the desired one (this phenomenon is called “striking of another color”), which is likely to degrade a color purity. If the pitch PHp is increased, although the width of the black non-light-emitting layers 17 can be kept sufficiently to reduce striking of another color, the resolution is degraded.

Recently, in order to enhance the visibility of the color picture tube, there is a demand that the radius of curvature of the outer surface of the useful portion 1 of the panel 3 is increased so as to bring the outer surface close to a substantially flat surface. Along with this, in terms of implosion-protection and visibility, it also is necessary to increase the radius of curvature of the inner surface of the useful portion 1 of the panel 3.

Furthermore, in order to allow the electron beams to land appropriately at desired positions on the inner surface of the panel 1, it is necessary to set the interval q between the panel 3 and the shadow mask 7 appropriately, and the radius of curvature of the perforated region of the shadow mask 7, in which the electron beam passage apertures 6 are formed, also should be increased in accordance with the radius of curvature of the inner surface of the panel 3.

In a shadow mask type color picture tube, according to its operation principle, the amount of the electron beams 11 passing through the electron beam passage apertures 6 of the shadow mask 7 to reach the phosphor screen 5 is ⅓ or less of the entire amount of the electron beams emitted from the electron gun 12, and the other electron beams strike the shadow mask 7 to be converted into thermal energy. Consequently, the shadow mask 7 is heated, and due to the thermal expansion caused by the heating of the shadow mask 7, so-called doming occurs, in which the shadow mask 7 changes its shape so as to swell on the phosphor screen 5 side. When the interval q between the phosphor screen 5 and the shadow mask 7 exceeds an allowable range due to the doming, the landing positions of the electron beams 11 with respect to the phosphor screen 5 are shifted to degrade the color purity.

The degree of a landing positional shift of the electron beams 11 due to the thermal expansion of the shadow mask 7 varies remarkably depending upon the brightness of an image pattern to be displayed and the duration time of the pattern. Particularly, in the case where an image pattern with locally high brightness is displayed, local doming occurs, and a local landing positional shift occurs in a short period of time. In this local doming, the amount of a landing positional shift also is large.

As shown in FIG. 4, it is assumed that a tube axis of the color picture tube is a Z-axis, an axis orthogonal to the Z-axis and parallel to a long side direction of the useful portion 1 of the panel 3 is an X-axis (major axis), and an axis orthogonal to the Z-axis and the X-axis and parallel to a short side direction of the useful portion 1 is a Y-axis (minor axis). It is assumed that a point which the Z-axis crosses in the useful portion 1 of the panel 3 is a center Sc of the useful portion 1, a crossing point between the X-axis and a peripheral edge of the useful portion 1 is a major axis end S_{H}, and a distance between the center S_{C} and the major axis end S_{H} along the X-axis is LH. The above-mentioned local doming occurs most significantly in the case of displaying a pattern with high brightness in an oval region 30 including a position (hereinafter, referred to as an “intermediate position”) S_{M} on the X-axis, which is away from the center S_{C} by (⅔)×LH, and a landing positional shift of the electron beams becomes largest in the region 30.

When the radius of curvature of the perforated region of the shadow mask 7 increases, the doming amount becomes large. Consequently, the amount of a landing positional shift of the electron beams increases, and the color purity is degraded greatly. Therefore, in a color picture tube in which the outer surface of the useful portion 1 of the panel 3 is substantially flat, in order to suppress doming, an alloy mainly containing iron and nickel having a low coefficient of thermal expansion is used generally as a material for the shadow mask 7. For example, an iron-nickel alloy such as 36 Ni Invar alloy (see Table 1 described later) is used. Such an alloy entails high cost, while having a coefficient of thermal expansion of 1 to 2×10⁻⁶ at 0° C. to 100° C., and being effective for suppressing doming. Furthermore, the iron-nickel alloy has large elasticity after annealing, so that it is difficult to form a curved surface from such an alloy by press forming and to obtain a desired curved surface. Even if the iron-nickel alloy is annealed, for example, at a high temperature of 900° C., the yield point strength is about 28×10⁷ N/m². Thus, it is necessary to treat the alloy at a considerably high temperature in order to set the yield point strength to be 20×10⁷ N/m² or less at which press forming generally is considered to be easy. Particularly, in a color picture tube with a flat panel outer surface, the radius of curvature of the shadow mask 7 generally is large, so that press forming is further difficult.

In the case where press forming is insufficient, and undesired stress remains in the shadow mask 7 after press forming, the residual stress changes the shape of the shadow mask 7 in the course of production of the color picture tube, which leads to the landing positional shift of the electron beams, resulting in the significant degradation in color purity.

On the other hand, with aluminum killed steel mainly containing high-purity iron, the yield point strength can be set to be 20×10⁷ N/m² or less by annealing at about 800° C., so that press forming is very easy. Thus, it is not necessary to keep the forming die temperature to be high in the course of press forming, which is required in an Invar alloy, and the productivity also is satisfactory.

However, the coefficient of thermal expansion of the aluminum killed steel is high (i.e., about 12×10⁻⁶ at 0° C. to 100° C.), which is disadvantageous for doming. Particularly, in the case of applying the aluminum killed steel to a color picture tube in which the outer surface of the useful portion 1 of the panel 3 is substantially flat, there arises a serious problem such as the significant degradation in color purity.

JP 2004-31305 A discloses a color picture tube using an inexpensive iron material for a shadow mask by defining the radius of curvature of a panel inner surface. However, in this color picture tube, a sufficient effect of suppressing doming cannot be obtained. Furthermore, the effect of suppressing the degradation in color purity during the occurrence of doming is not sufficient, either. When an attempt is made to obtain a sufficient effect of suppressing doming, the weight of a panel increases, compared with the case of using an expensive Invar material. Furthermore, the thickness difference between the center and the periphery of the panel increases, so that a panel cracks frequently in a heating process in the course of production.

Furthermore, even when the inner surface of the useful portion 1 is made relatively flat so as to flatten the outer surface of the useful portion 1 of the panel 3, in order to keep the compressive strength of the shadow mask 7 in a satisfactory state and suppress the occurrence of doming, it is preferable to decrease the radius of curvature of the perforated region of the shadow mask 7. Consequently, the interval between the panel 3 and the shadow mask 7 becomes small at the center and becomes large on the periphery. Therefore, the pitch of the electron beam passage apertures in the X-axis direction generally is set to be small at the center and large on the periphery.

Accordingly, the pitch of the electron beam passage apertures in the X-axis direction cannot be set to be sufficiently large in the vicinity of the position on the shadow mask 7 corresponding to the intermediate position S_{M} in FIG. 4. Thus, a sufficient width of the black non-light-emitting layers 17 cannot be maintained. More specifically, the distance between a phosphor of a first color that originally is supposed to be irradiated with an electron beam and a phosphor of a second color adjacent to the phosphor of the first color with the black non-light-emitting layer 17 interposed therebetween becomes small. As a result, even if the doming amount can be suppressed to be small, the distance (margin) between the electron beam whose landing position is shifted due to doming and the phosphor of the second color becomes small, and striking of another color occurs even with a slight doming amount; thus, the color purity is likely to be degraded.

As described above, in the case of increasing the radius of curvature of the shadow mask so as to allow it to correspond to that of the panel in the color picture tube having a panel with the radius of curvature of the outer surface increased so as to enhance visibility, when an alloy mainly containing iron and nickel is used as a material for the shadow mask, it is difficult to form a curved surface from such an alloy by press forming and to obtain a desired curved surface. On the other hand, when an iron material that is inexpensive and has satisfactory formability is used, the landing positional shift of the electron beams occurs due to the local doming of the shadow mask during the operation of the color picture tube, and finally, an electron beam overpasses the black non-light-emitting layer to illuminate a phosphor different from the desired one, with the result that the color purity of the color picture tube is degraded. On the other hand, when the radius of curvature of the shadow mask is decreased, and the radius of curvature of the panel inner surface is decreased in accordance with the decrease in radius of curvature of the shadow mask, the weight of the panel increases, and the uniformity of brightness degrades.

### SUMMARY OF THE INVENTION

The present invention has an object of providing a color picture tube that has satisfactory visibility, has less degradation in color purity due to doming while having a shadow mask made of an inexpensive material with satisfactory formability, and is excellent in uniformity of brightness.

A color picture tube of the present invention includes a panel in which a phosphor screen is formed on an inner surface of a substantially rectangular useful portion, and a shadow mask. The phosphor screen is composed of a black non-light-emitting layer and a phosphor formed in a region where the black non-light-emitting layer is not formed. The shadow mask includes a substantially rectangular perforated region opposed to the phosphor screen, in which a number of electron beam passage apertures are arranged in vertical and horizontal directions, and a radius of curvature of an outer surface of the useful portion of the panel is 10,000 mm or more.

Assuming that a tube axis is a Z-axis, an axis orthogonal to the Z-axis and parallel to a long side direction of the useful portion is an X-axis, an axis orthogonal to the Z-axis and parallel to a short side direction of the useful portion is a Y-axis, a distance (unit: mm) along the X-axis between a point where the X-axis and a peripheral edge of the useful portion cross each other and a center of the useful portion is LH, and a total number of rows of apertures composed of the electron beam passage apertures arranged on a straight line substantially parallel to the Y-axis is N, the following expression:
0.9≦LH/N≦1.0
is satisfied.

Furthermore, assuming that a pitch of the rows of apertures adjacent to each other is PHC at a center of the perforated region, PHH at a major axis end where the X-axis and a peripheral edge of the perforated region cross each other, and PHM at a point away from the center of the perforated region by ⅔ of a distance MH between the center of the perforated region and the major axis end along the X-axis, the following expressions:
PHM/PHC≦1.2
PHH/PHC≦1.4
are satisfied.

Furthermore, the shadow mask is made of a material containing 95% or more of iron.

### BRIEF DESCRIPTION OF THE DRAWINGS

FIG. 1 is a cross-sectional view showing a general configuration of a color picture tube.

FIG. 2 is a cross-sectional view showing a method for forming a phosphor screen.

FIG. 3A is an enlarged front view of a phosphor screen, and FIGS. 3B and 3C are enlarged front views of inappropriate phosphor screens.

FIG. 4 is a view showing an example of a display pattern in which local doming of a shadow mask is likely to occur.

FIG. 5 is a perspective view of one embodiment of a shadow mask to be mounted on a color picture tube according to the present invention.

FIG. 6 is a diagram showing changes along an X-axis in an X-axis direction pitch of rows of apertures in shadow masks of color picture tubes according to Example 1 and Comparative Example 1.

FIG. 7 is a perspective view showing an inner surface shape of a panel.

FIG. 8 is a diagram showing changes along an X-axis in a sagging amount of a panel inner surface and a shadow mask in the color picture tubes according to Example 1 and Comparative Example 1.

FIG. 9 is a diagram showing changes along an X-axis in a ratio D/PH of an aperture width D in an X-axis direction of electron beam passage apertures with respect to an X-axis direction pitch PH of rows of apertures in shadow masks of the color picture tubes according to Example 1 and Comparative Example 1.

FIG. 10 shows a state where a phosphor, which is adjacent to a phosphor that originally is supposed to be irradiated with an electron beam, is irradiated due to doming.

FIG. 11 is a diagram showing changes along an X-axis in thickness of a panel in the color picture tubes according to Example 1 and Comparative Example 1.

FIG. 12 is a diagram showing changes in thickness of a panel along a direction passing through an intermediate position S_{M} and being parallel to a Y-axis in the color picture tubes according to Example 1 and Comparative Example 1.

FIGS. 13A and 13B are diagrams showing a transmittance distribution of a useful portion of a panel in the color picture tubes according to Example 1 and Comparative Example 1: FIG. 13A is a transmittance distribution diagram along an X-axis, and FIG. 13B is a transmittance distribution diagram along a diagonal axis.

FIGS. 14A and 14B are diagrams showing changes in a brightness ratio with respect to the center of the useful portion of the panel in the color picture tubes according to Example 1 and Comparative Example 1: FIG. 14A is a brightness ratio change diagram along an X-axis, and FIG. 14B is a brightness ratio change diagram along a diagonal axis.

FIG. 15 is a diagram showing changes along an X-axis and a diagonal axis in an area ratio of black non-light-emitting layers per unit area in the color picture tube according to Example 1.

FIG. 16 is a diagram showing changes along an X-axis in an X-axis direction pitch of rows of apertures in shadow masks of the color picture tubes according to Example 2 and Comparative Example 2.

### DETAILED DESCRIPTION OF THE INVENTION

According to the present invention, a color picture tube can be provided, which has satisfactory visibility, has less degradation in color purity due to doming while having a shadow mask made of an inexpensive material with satisfactory formability, and is excellent in uniformity of brightness.

Hereinafter, the present invention will be described in detail with reference to the drawings.

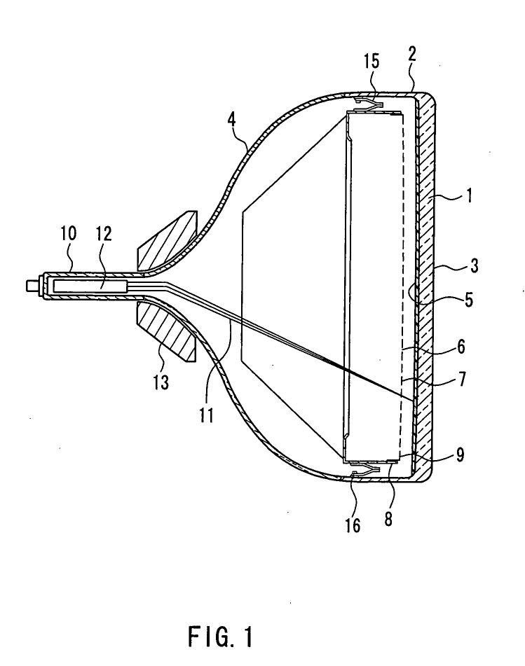

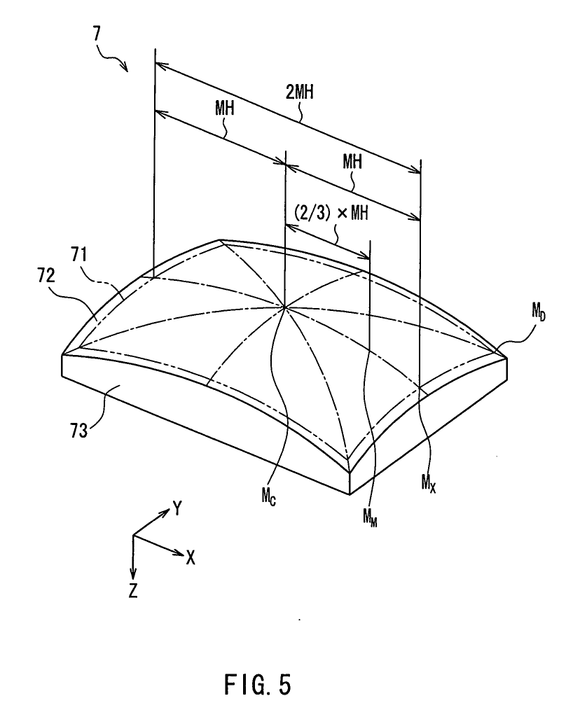

FIG. 1 is a cross-sectional view of a color picture tube according to one embodiment of the present invention. The color picture tube includes an envelope composed of a panel 3 with a skirt portion 2 provided on the periphery of a substantially rectangular useful portion 1 on which an image is displayed, and a funnel 4 in a funnel shape connected to the skirt portion 2. On an inner surface of the useful portion 1 of the panel 3, a phosphor screen 5 composed of three-color phosphor layers respectively emitting blue, green, and red light is formed. A shadow mask 7 having a substantially rectangular perforated region 71 (see FIG. 5), in which a number of electron beam passage apertures 6 are arranged in vertical and horizontal directions, is placed so as to be opposed to the phosphor screen 5. The shadow mask 7 is held by a mask frame 8 having a substantially rectangular frame shape, having a substantially L-shaped cross-section. A shadow mask structure 9 composed of the shadow mask 7 and the mask frame 8 is supported detachably with respect to the panel 3 with one end of a substantially V-shaped elastic support 15 attached to each corner portion or respectively on short sides and long sides of the mask frame 8, and the other end of the elastic support 15 engaged with a stud pin 16 fixed on an inner wall of the skirt portion 2 of the panel 3. An electron gun 12 emitting three electron beams 11 is housed in a neck 10 of the funnel 4. The three electron beams 11 emitted by the electron gun 12 are deflected by a magnetic field generated by a deflection apparatus 13 mounted on an outer side of the funnel 4, and allowed to scan the phosphor screen 5 in horizontal and vertical directions via the shadow mask 7, thereby displaying a color image.

FIG. 5 is a perspective view of the shadow mask 7. The shadow mask 7 includes a perforated region 71 opposed to the phosphor screen 5 and made of a substantially rectangular curved surface in which a number of electron beam passage apertures (not shown) are formed, a non-perforated region 72 placed on the periphery of the perforated region 71 so as to surround it, and a skirt portion 73 connected to the non-perforated region 72 and bent with respect to the non-perforated region 72. The skirt portion 73 is fitted inside the mask frame 8, and both of them are welded to each other, whereby the shadow mask 7 is integrated with the mask frame 8. The shadow mask 7 is produced by subjecting a metal flat plate, in which electron beam passage apertures are formed by etching, to press forming.

The outer surface of the useful portion 1 of the panel 3 forming the color picture tube of the present invention is a substantially flat surface with a radius of curvature of 10,000 mm or more so as to enhance visibility. Thus, in terms of the strength of the envelope with respect to the atmospheric pressure and the visibility, it is necessary to increase the radius of curvature of the inner surface of the useful portion 1.

In order to display an image without color displacement on the phosphor screen 5 of the color picture tube, it is necessary that the three electron beams 11 having passed through the electron beam passage apertures 6 formed in the shadow mask 7 should land correctly on the three-color phosphor layers of the phosphor screen 5. For this purpose, the relative position between the panel 3 and the shadow mask 7 needs to be kept correctly.

Thus, along with the increase in radius of curvature of the inner surface of the useful portion 1, it also is necessary to increase the radius of curvature of the perforated region 71 of the shadow mask 7. In general, when the radius of curvature of the perforated region 71 of the shadow mask 7 is increased, it is difficult to form a curved surface of the perforated region 71 by press forming. According to the present invention, a material containing 95% or more of iron is used as a material for the shadow mask 7. This remarkably enhances the formability of a curved surface at low cost.

However, such a material has a high coefficient of thermal expansion. Therefore, when an image pattern with locally high brightness is displayed, local doming occurs, and the amount of local mislanding of electron beams becomes large in a short period of time.

As measures for addressing the above-mentioned problem, it is considered to decrease the radius of curvature of the perforated region 71 of the shadow mask 7, and also minimize the radius of curvature of the inner surface of the useful portion 1 of the panel 3 in accordance with the decrease in the radius of curvature of the perforated region 71. However, in this case, owing to the increase in thickness of the periphery of the panel 3, there arise problems such as the cracking of the panel 3 caused by thermal stress in the course of production, the degradation in brightness on the periphery of the screen, and the increase in weight.

The present invention solves the above-mentioned problems. One example thereof will be described below by exemplifying a color picture tube with a diagonal size of 51 cm, an aspect ratio of 4:3, and a radius of curvature of the outer surface of the useful portion 1 of the panel 3 of 20,000 mm (hereinafter, referred to as “Example 1”).

The outer surface of the useful portion 1 of the panel 3 of the color picture tube of Example 1 is flattened sufficiently as described above, and the shadow mask 7 is made of aluminum killed steel shown in Table 1 made of high-purity iron with a coefficient of thermal expansion of 12×10⁻⁶ at 0C to 100° C. Therefore, the sufficient formability is ensured while entailing low cost.

TABLE 1

| Component | Aluminum killed steel | Invar alloy |
|---|---|---|
| C | 0.002 | 0.009 |
| Mn | 0.3 | 0.47 |
| Si | <0.01 | 0.13 |
| P | 0.016 | 0.005 |
| S | 0.009 | 0.002 |
| Al | 0.052 | — |
| Ni(+Co) | — | 36.5 |
| Fe | Remaining portion | Remaining portion |
| | | (Unit: %) |

For convenience of the description, it is assumed that a tube axis direction axis of the color picture tube is a Z-axis, an axis orthogonal to the Z-axis and parallel to a long side direction of the useful portion 1 of the panel 3 is an X-axis, and an axis orthogonal to the Z-axis and parallel to a short side direction of the useful portion 1 is a Y-axis.

Furthermore, as shown in FIG. 5, a size on the X-axis of the perforated region 71 of the shadow mask 7 is 2 MH, a center (position which the Z-axis crosses) of the perforated region 71 is M_{C}, a position where the X-axis and a peripheral edge of the perforated region 71 cross each other is a major axis end M_{X}, and a position away from the center M_{C} by (⅔)×MH along the X-axis is an intermediate position M_{M}.

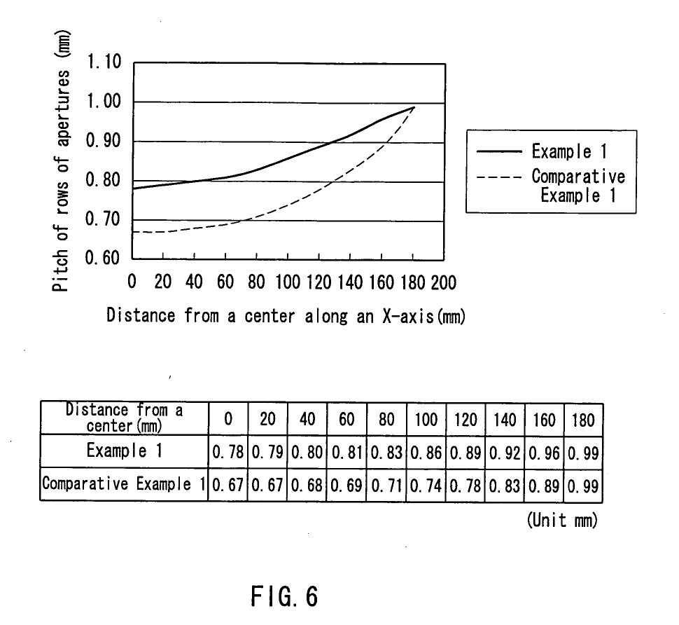

In the perforated region 71 of the shadow mask 7, N rows of apertures are arranged in the X-axis direction, each of which has a configuration in which a plurality of electron beam passage apertures 6 having a substantially slot shape with a Y-axis direction being a longitudinal direction, are arranged on a straight line substantially parallel to the Y-axis. The X-axis direction pitch of adjacent rows of apertures changes in the X-axis direction as shown in FIG. 6. FIG. 6 shows changes along the X-axis in the X-axis direction pitch of rows of apertures only with respect to one side of the Y-axis. “Comparative Example 1” shows changes in the X-axis direction pitch of rows of apertures in a shadow mask of a conventional color picture tube in which the perforated region 71 has a spherical surface having a single radius of curvature. A lower column in FIG. 6 shows numerical values of a pitch of rows of apertures at main portions on the X-axis.

As shown in FIG. 6, in any of Example 1 and Comparative Example 1, the X-axis direction pitch of rows of apertures increases with a distance from the center M_{C}. The X-axis direction pitch of rows of apertures of Example 1 is larger than that of Comparative Example 1, and the difference therebetween increases toward the center M_{C}, gradually decreases with a distance from the center M_{C}, and at the major axis end M_{X}, the X-axis direction pitches of both the rows of apertures are substantially the same value. More specifically, in Example 1, compared with Comparative Example 1, the ratio of a value of the X-axis direction pitch of rows of apertures at the major axis end M_{X} with respect to that at the center M_{C} is smaller.

Assuming that the X-axis direction pitch of rows of apertures at the center M_{C} is PHC, the X-axis direction pitch of rows of apertures at the major axis end M_{X} is PHH, and the X-axis direction pitch of rows of apertures at the intermediate position M_{M} is PHM, in Example 1, the following expressions:
PHM/PHC=1.14
PHH/PHC=1.27
are satisfied. In the present invention, the following expressions:
PHM/PHC≦1.2
PHH/PHC≦1.4
should be satisfied. Example 1 satisfies the above expressions

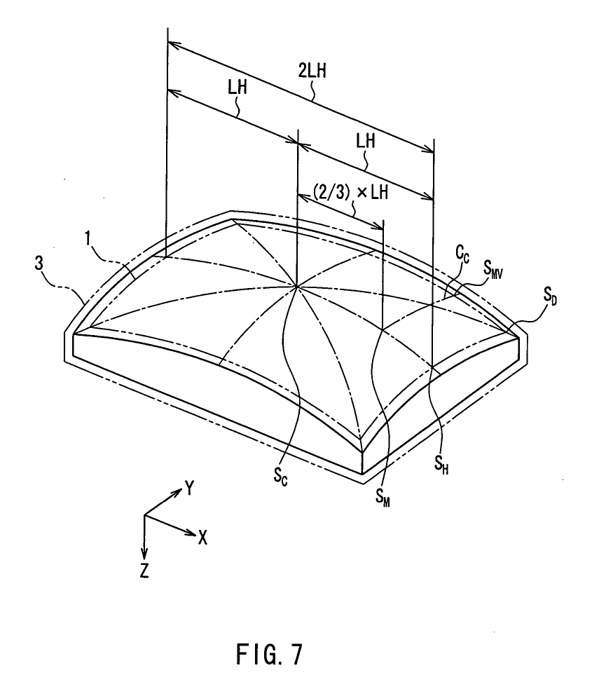

FIG. 7 is a perspective view showing an inner surface shape of the panel 3. As shown in the figure, it is assumed that the size on the X-axis of the useful portion 1 is 2 LH, the center (position that the Z-axis crosses) of the useful portion 1 is S_{C}, the position where the X-axis and the peripheral edge of the useful portion 1 cross each other is a major axis end S_{H}, a point away from the center S_{C} by (⅔)×LH along the X-axis is S_{M}, and the position where the diagonal axis and the peripheral edge of the useful portion 1 cross each other is a diagonal axis end S_{D}. Herein, the “useful portion 1” refers to a region on the inner surface of the panel 3 in which red, green, and blue three-color phosphor layers are formed, or a region on an outer surface of the panel 3 corresponding to this region. Assuming that the total number of rows of apertures of the electron beam passage apertures 6 formed in the shadow mask 7 is N, in Example 1, LH/N=0.91 (mm) is satisfied. Herein, the unit of LH is mm. In general, when 0.9 (mm)≦LH/N≦1.0 (mm) is satisfied, the X-axis direction pitch of rows of apertures can be set to be large while a required resolution is ensured.

In the color picture tube of Example 1 according to the present invention, the X-axis direction pitch of rows of apertures on the periphery of the perforated region 71 is set to be equal to that of Comparative Example 1, and the X-axis direction pitch of rows of apertures in a region between the center portion (in particular, the center M_{C}) and the intermediate position M_{M} is set to be larger than that of Comparative Example 1, whereby the difference in the X-axis direction pitch of rows of apertures between the peripheral portion and the center portion is set to be small. Consequently, the X-axis direction pitch of rows of apertures on the periphery of the intermediate position M_{M} is kept sufficiently.

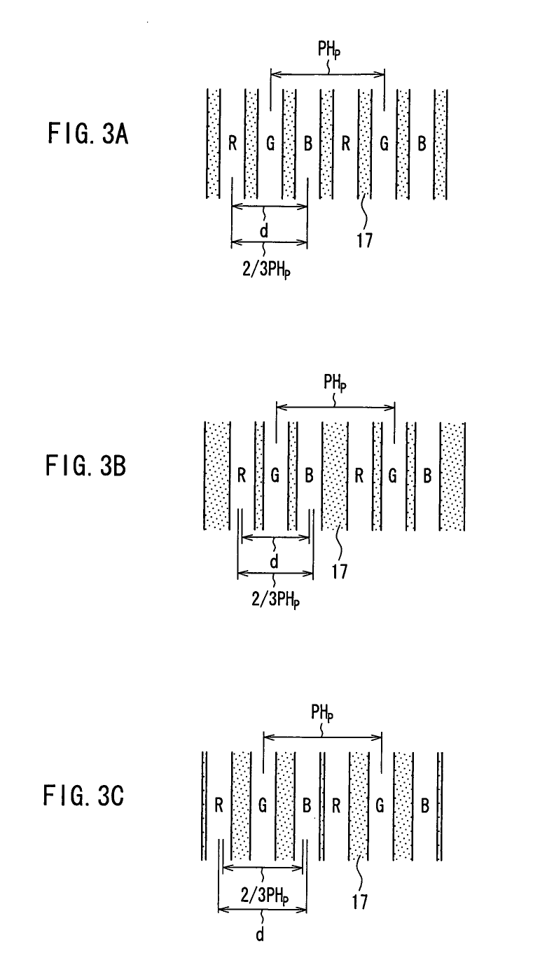

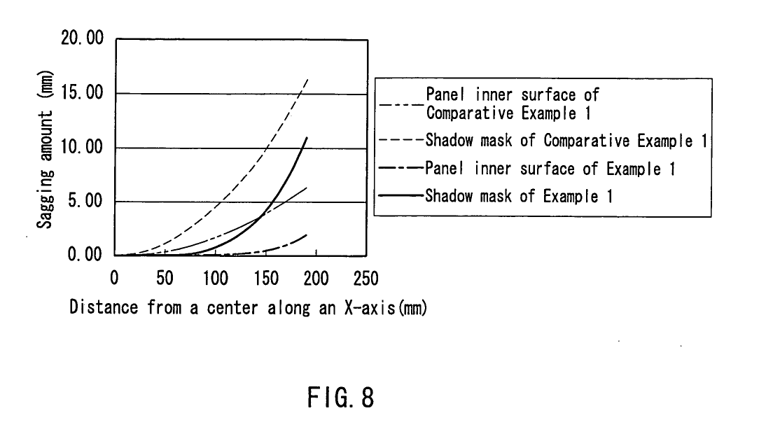

Next, the curved surface shapes of the inner surface of the panel 3 and the shadow mask 7 required for realizing the above-mentioned arrangement of rows of apertures will be described. These curved surface shapes can be expressed with a “sagging amount” that is a displacement amount in the Z-axis direction at each position with respect to the centers S_{C}, M_{C}. FIG. 8 shows changes along the X-axis in a sagging amount of the inner surface of the panel 3 and the shadow mask 7 according to Example 1 and Comparative Example 1. In order to form the phosphor stripes uniformly as shown in FIG. 3A as described above, it is necessary to set appropriately the interval (q value) between the panel 3 and the shadow mask 7.

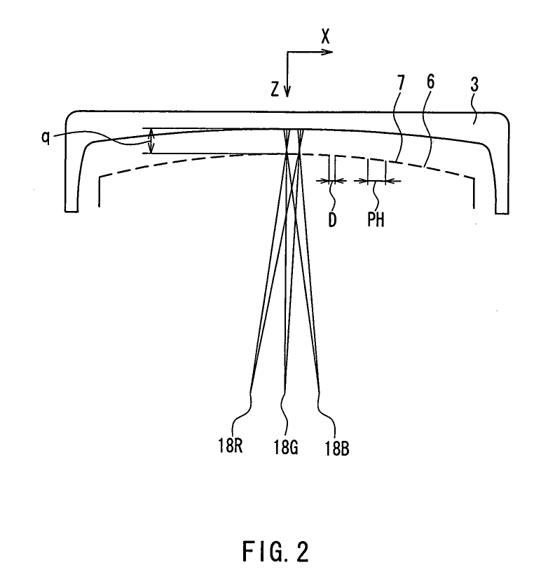

As shown in FIG. 2, in order to set an interval, on the inner surface of the panel 3, of adjacent light beams among three light beams from the light sources 18R, 18G, and 18B of the light-exposure apparatus to be a desired value, it is important to set appropriately an X-axis direction pitch of rows of apertures including the electron beam passage apertures 6 and the q value.

In Example 1, the X-axis direction pitch of rows of apertures is set as shown in FIG. 6, whereby the changes along an X-axis in a sagging amount of the shadow mask 7 are set as shown in FIG. 8. In Example 1, as shown in FIG. 8, the sagging amounts at the intermediate position M_{M} and on the periphery thereof are smaller than those of Comparative Example 1. When a sagging amount change curve along the X-axis in Example 1 is approximated by a higher-order expression with an X-coordinate value being a variable, the ratio of a higher-order component can be increased relatively, so that the effect of suppressing doming can be obtained.

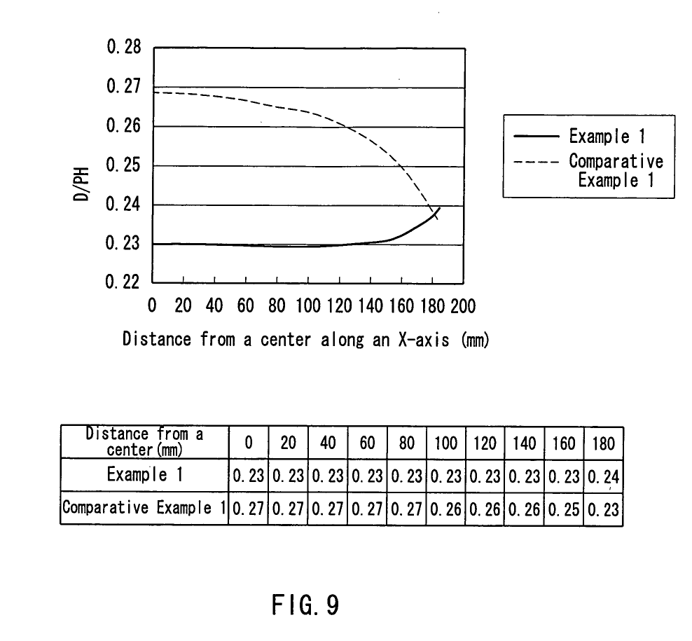

Furthermore, assuming that the aperture width in the X-axis direction of the electron beam passage apertures 6 is D, and the X-axis direction pitch of rows of apertures is PH, a ratio D/PH changes as shown in FIG. 9 in the X-axis direction. Alower column shown in FIG. 9 shows numerical values of the ratio D/PH at main positions on the X-axis. In Example 1, by setting the changes in the X-axis direction of the ratio D/PH as shown in FIG. 9, even if doming occurs to cause a landing positional shift of electron beams, the width of the black non-light-emitting layers 17 can be kept sufficient with respect to the positional shift amount. Thus, even in the case where doming occurs, the possibility of irradiating a phosphor other than a phosphor that originally is supposed to be irradiated with an electron beam can be reduced. Therefore, the degradation in color purity can be suppressed substantially.

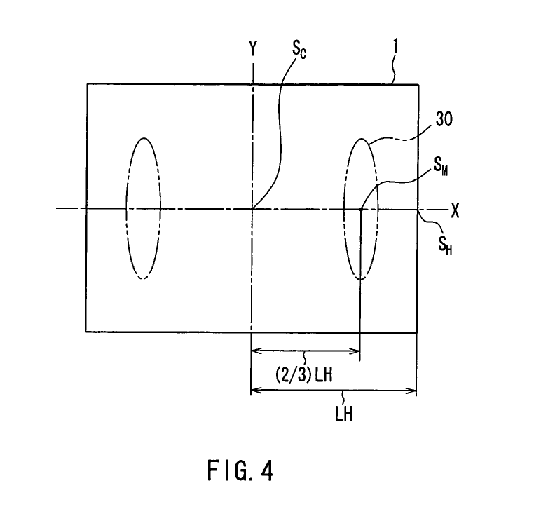

In particular, it is effective for a doming pattern occurring in the case of displaying a pattern with high brightness in the region 30 in FIG. 4, to set the ratio D/PH to be small at the intermediate position M_{M}. Because of this, even when doming occurs, the distance (margin) between an electron beam and a phosphor adjacent to a phosphor that originally is supposed to be irradiated with that electron beam becomes uniform over the entire screen, so that the uniformity of color purity of the screen can be kept satisfactorily.

Assuming that the aperture width in the X-axis direction of the electron beam passage apertures 6 at the center M_{C} of the perforated region 71 is DC, the aperture width in the X-axis direction of the electron beam passage apertures 6 at the major axis end M_{X} is DH, and the aperture width in the X-axis direction of the electron beam passage apertures 6 at the intermediate position M_{M} is DM, in the present invention, the following expressions:
DM/PHM≦0.24
DH/PHH≦0.25
preferably are satisfied. Because of this, the above-mentioned margin can be kept sufficiently, and the degradation in color purity can be prevented further. In particular, it is effective to set a ratio DM/PHM to be small at the intermediate position M_{M}. In Example 1, the following expressions:
DM/PHM=0.23
DH/PHH=0.24
are set.

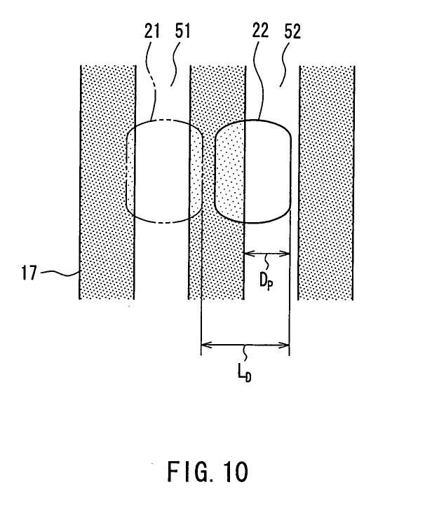

The effect of preventing the degradation in color purity of the color picture tubes according to Example 1 and Comparative Example 1 will be described using Table 2. Table 2 shows experimental results in the case of displaying a pattern with high brightness in the region 30 in FIG. 4 where the degradation in color purity is most remarkable. In Table 2, an “electron beam movement amount at an intermediate position” refers to an electron beam movement amount L_{D} in the case where, at the intermediate position S_{M} of the inner surface of the panel 3, as shown in FIG. 10, an electron beam moves to a position 22, instead of a position 21 at which the electron beam originally is supposed to land, due to the doming of the shadow mask 7. Furthermore, an “electron beam intrusion amount with respect to an adjacent phosphor” refers to an intrusion amount D_{P} of the landing position 22 of the electron beam with respect to a phosphor 52 in the case where, at the intermediate position S_{M}, as shown in FIG. 10, the landing position of the electron beam moves from the position 21 to the position 22 due to the doming of the shadow mask 7, whereby the electron beam does not irradiate a phosphor 51 that originally is supposed to be irradiated and irradiates the phosphor 52 adjacent to the phosphor 51. Furthermore, a “diagonal axis average radius of curvature” refers to an apparent radius of curvature of a shadow mask on a surface including the Z-axis and the diagonal axis, obtained from the sagging amount at the diagonal axis end M_{D} of the shadow mask 7 (see FIG. 5). The value of the diagonal axis average radius of curvature of Example 1 being the same as that of Comparative Example 1 indicates that the sagging amounts at these diagonal axis ends M_{D} are the same.

TABLE 2

| | | Electron beam | | Electron beam | | Diagonal axis |
|---|---|---|---|---|---|---|
| | | movement amount at | | intrusion amount | | average |
| | | an intermediate | | with respect to an | | radius of |
| Diagonal size | | position | | adjacent phosphor | | curvature |
| 51 cm | Comparative | 222 μm | | 168 μm | | 1694 mm |
| | Example 1 | | | | | |
| | Example 1 | 128 μm | (58%) | 53 μm | (31%) | |
| 60 cm | Comparative | 289 μm | — | 235 μm | | 2209 mm |
| | Example 2 | | | | | |
| | Example 2 | 165 μm | (57%) | 90 μm | (38%) | |

The electron beam movement amount LD at the intermediate position SM in Example 1 is reduced to 58% of that of Comparative Example 1 having a single radius of curvature of 1694 mm. More specifically, the curved surface shape of the shadow mask 7 in Example 1 according to the present invention has an effect of reducing the electron beam movement amount L_{D} at the intermediate position S_{M}.

As is apparent from FIG. 10, the mere decrease in the movement amount L_{D} of the landing position of an electron beam is not sufficient for the degradation in color purity. It is necessary that the electron beam having moved due to doming does not irradiate the phosphor 52 different from the desired phosphor 51. That is, the magnitude of the electron beam intrusion amount D_{P} with respect to the adjacent phosphor 52 has a large effect on the color purity.

The electron beam intrusion amount D_{P} with respect to the adjacent phosphor at the intermediate position S_{M} in Example 1 is reduced to 31% of that of Comparative Example 1. The ratio 31% of the electron beam intrusion amount D_{P} in Example 1 with respect to that in Comparative Example 1 is smaller than the ratio 58% of the electron beam movement amount L_{D} in Example 1 with respect to that in Comparative Example 1. This shows that, in Example 1, the effect of preventing the degradation in color purity is obtained by optimizing various conditions such as the arrangement of the electron beam passage apertures 6 of the shadow mask 7, the inner surface shape of the panel 3, and the phosphors and the black non-light-emitting layers 17 forming the phosphor screen 5, as well as the curved surface shape of the shadow mask 7.

In the conventional color picture tube, in order to flatten the outer surface of the useful portion 1 of the panel 3, the inner surface of the useful portion 1 is made relatively flat, and the radius of curvature of the shadow mask 7 is set to be small so as to suppress doming, while the X-axis direction pitch of rows of apertures of the electron beams passage apertures 6 is set to be small at the center in the X-axis direction and large on the periphery thereof.

Therefore, the X-axis direction pitch of rows of apertures cannot be set sufficiently large at the intermediate position M_{M}. Thus, even if the doming amount is suppressed to be small, the margin of the electron beam whose position is shifted due to doming with respect to the adjacent phosphor 52 cannot be kept sufficiently, with the result that the color purity is likely to be degraded. For example, even if the electron beam movement amount L_{D} due to doming can be suppressed to be small, the electron beam intrusion amount D_{P} cannot be suppressed to be small. Thus, unlike Example 1, the improvement ratio with respect to the electron beam intrusion amount D_{P} is rather degraded, compared with the improvement ratio with respect to the electron beam movement amount L_{D}.

According to the present invention, in addition to the reduction in doming and the electron beam movement amount L_{D} due to doming, the curved surface shape of the shadow mask, the X-axis direction pitch of rows of apertures, the X-axis direction aperture width of the electron beam passage apertures 6, and the like are set appropriately, whereby the electron beam intrusion amount D_{P} with respect to the adjacent phosphor 52 is reduced. Consequently, the degradation in color purity can be reduced.

In the color picture tube of Example 1, in order to realize the above-mentioned curved surface of the shadow mask, the thickness of the useful portion 1 of the panel 3 is set to be as follows.

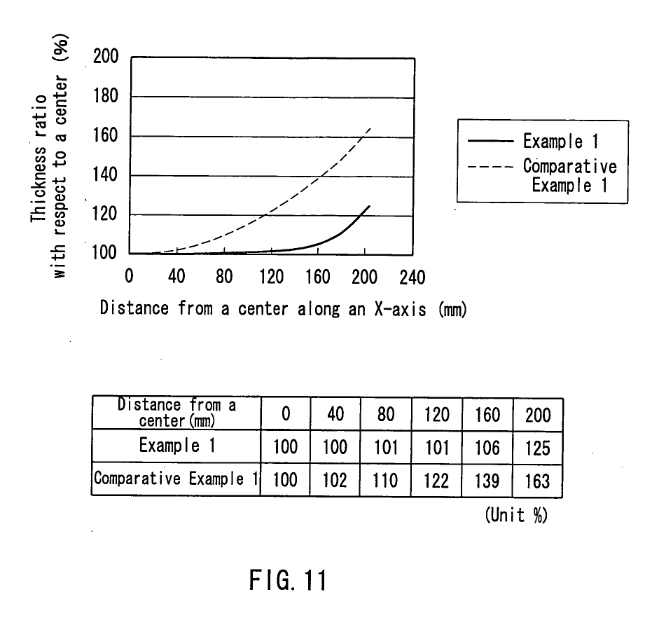

FIG. 11 shows changes along an X-axis in thickness of the useful portion 1 as a ratio (%) with respect to the center S_{C}, regarding Example 1 and Comparative Example 1. Alower column in FIG. 11 shows numerical values of a thickness ratio at main portions on the X-axis. Assuming that the thickness at the center S_{C} is T_{C}, and the thickness at the major axis end S_{H} is T_{H}, the ratio therebetween is set to be T_{H}/T_{C}=1.21 in Example 1. In general, it is preferable that T_{H}/T_{C}≦1.3, since the weight of a panel can be reduced, and the uniformity of display brightness in the useful portion 1 can be kept easily.

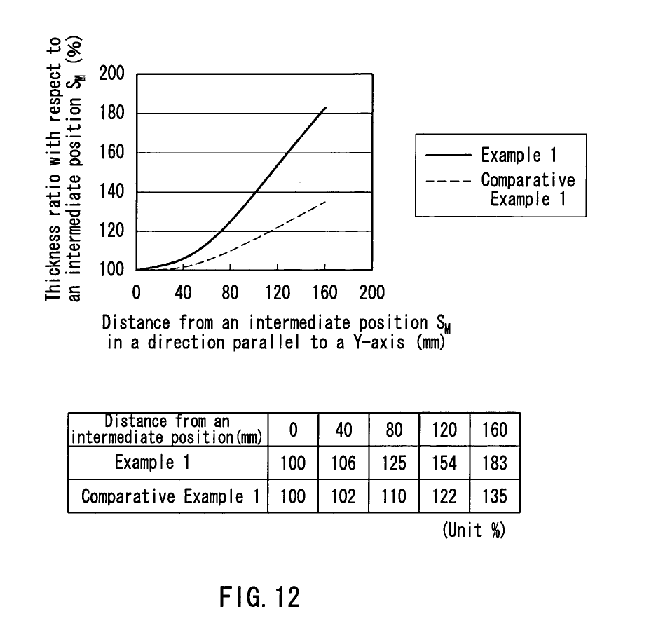

FIG. 12 shows changes in thickness of the useful portion 1 (changes along a curve C_{C} in FIG. 7) in a direction passing through the intermediate position S_{M} and being parallel to the Y-axis as a ratio (%) with respect to the intermediate position S_{M}, regarding Example 1 and Comparative Example 1. A lower column in FIG. 12 shows numerical values of a thickness ratio at main portions on an axis passing through the intermediate position S_{M} and being parallel to the Y-axis. Assuming that the thickness at the intermediate position S_{M} is T_{M}, and the thickness at a position S_{MV} (see FIG. 7) where a surface including the intermediate position S_{M} and being parallel to the YZ-plane crosses the peripheral edge of the useful portion 1 is T_{L}, the ratio therebetween is set to be T_{L}/T_{M}=1.8 in Example 1. In order to satisfy both the suppression of doming and the uniformity of brightness, it is preferable that 1.6≦T_{L}/T_{M}≦1.9 is satisfied.

By combining the shadow mask 7 having the above-mentioned X-axis direction pitch of rows of apertures of the electron beam passage apertures 6 with the panel 3 having the above-mentioned curved surface shape, the electron beam movement amount due to doming of the shadow mask can be decreased as shown in Table 2, and a large effect of suppressing doming can be obtained.

More specifically, according to the present invention, the radius of curvature of the inner surface of the useful portion 1 of the panel 3 is set to be large as shown in FIG. 8, and the thickness difference of the panel between the center S_{C} and the major axis end S_{H} in the X-axis direction is set to be small as shown in FIG. 11. This realizes simultaneously two effects: the uniformity of brightness and the reduction in a displacement amount of the shadow mask due to doming.

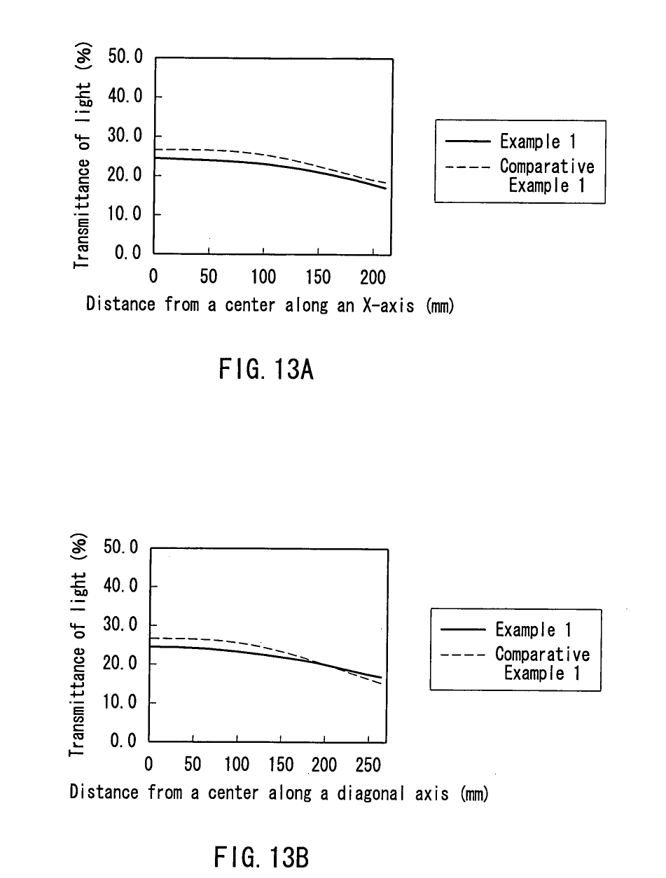

FIGS. 13A and 13B respectively show a transmittance distribution of the useful portion 1 of the panel in which black non-light-emitting layers are formed. FIG. 13A is a transmittance distribution diagram along the X-axis, and FIG. 13B is a transmittance distribution diagram along a diagonal axis. Assuming that the aperture width in the X-axis direction of the electron beam passage apertures 6 is D, and the X-axis direction pitch of rows of apertures of the electron beam passage apertures 6 is PH, when D/PH is set to be small, and the area ratio of the black non-light-emitting layers 17 per unit area is set to be large, the brightness is degraded.

According to the present invention, even when the transmittance at the center S_{C} of the useful portion 1 under the condition that the black non-light-emitting layers 17 and the phosphor layers are not formed is set to be 40 to 60% to enhance a contrast, by rightsizing the thickness of the panel 3 as described above, the degradation in brightness particularly along the X-axis is very small, and the degradation in brightness can be suppressed even at the diagonal axis end S_{D}.

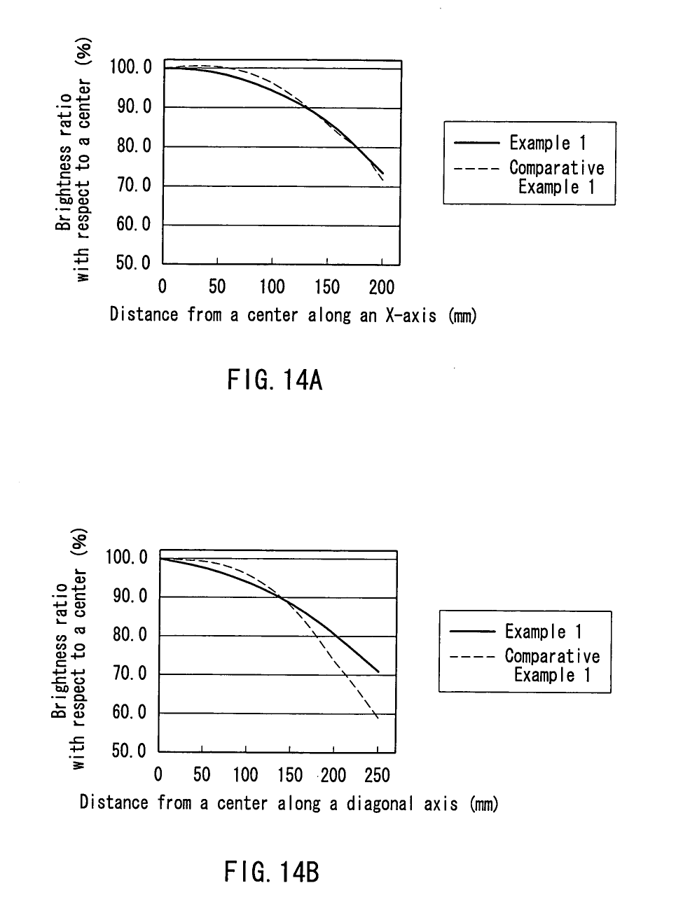

FIGS. 14A and 14B show a brightness distribution of the useful portion 1 of the panel 3 as a brightness ratio based on the center S_{C}. FIG. 14A is a brightness ratio change diagram along the X-axis, and FIG. 14B is a brightness ratio change diagram along the diagonal axis. In Example 1, compared with Comparative Example 1, the uniformity of brightness is excellent, and at any of the major axis end S_{H}, the minor axis end, and the diagonal axis end S_{D} that are peripheral edges of the useful portion 1, the brightness with respect to the center S_{C} is in a range of 70 to 80%. Therefore, Example 1 is satisfactory in terms of visibility.

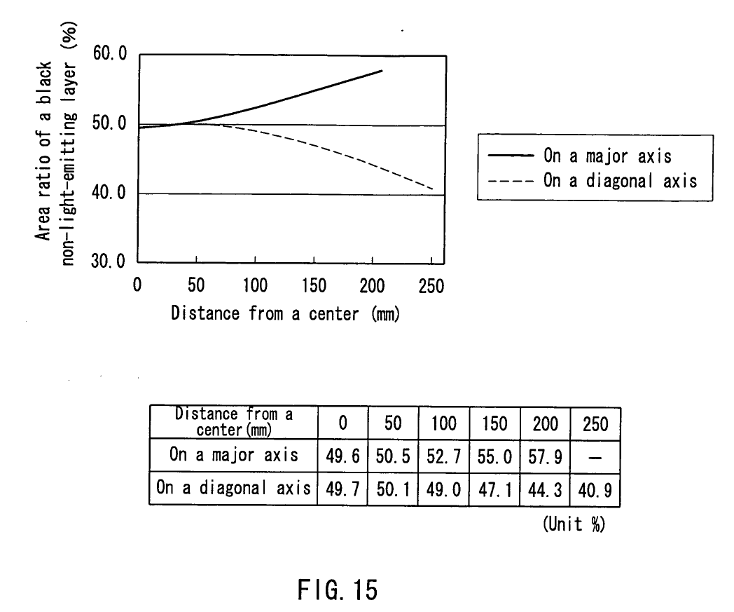

Furthermore, assuming that the area ratio of the black non-light-emitting layers 17 per unit area in the useful portion 1 is BRC at the center S_{C} of the useful portion 1, BRH at the major axis end S_{H}, and BRD at the diagonal axis end S_{D}, it is preferable that BRD≦BRC≦BRH is satisfied. FIG. 15 shows changes along the X-axis and the diagonal axis in an area ratio of the black non-light-emitting layers 17 per unit area. The horizontal axis represents a distance from the center S_{C}. A lower column in FIG. 15 shows numerical values of an area ratio at main portions.

In a conventional color picture tube in which the outer surface of the useful portion 1 of the panel 3 is flat, and an Invar material is adopted as a material for the shadow mask 7, the mislanding of electron beams is likely to occur on the periphery of the useful portion 1 after a thermal process due to the difference in a coefficient of thermal expansion between the shadow mask 7 and the mask frame 8 made of an iron material. In order to prevent this, conventionally, the ratio of the black non-light-emitting layers per unit area is set to be the smallest at the center S_{C} and large on the periphery thereof. However, in Example 1, the shadow mask 7 is made of aluminum killed steel shown in Table 1, and the thickness distribution of the panel 3 is set as shown in FIG. 12, whereby the area ratio of the black non-light-emitting layers 17 per unit area can be set as described above, unlike the conventional example. Consequently, the uniformity of overall brightness is enhanced largely, and furthermore, the margin of an electron beam whose position is shifted due to doming with respect to the adjacent phosphor 52 can be kept sufficiently.

Furthermore, by setting T_{H}/T_{C} to be small, the weight of the panel 3 of Example 1 becomes 9.5 kg, which is equal to that using an expensive Invar material.

Next, as another example, the case of a color picture tube will be described in which a diagonal useful size is 60 cm, an aspect ratio is 4:3, and a radius of curvature of an outer surface of the useful portion 1 of the panel 3 is 50,000 mm. Hereinafter, this example will be referred to as “Example 2”.

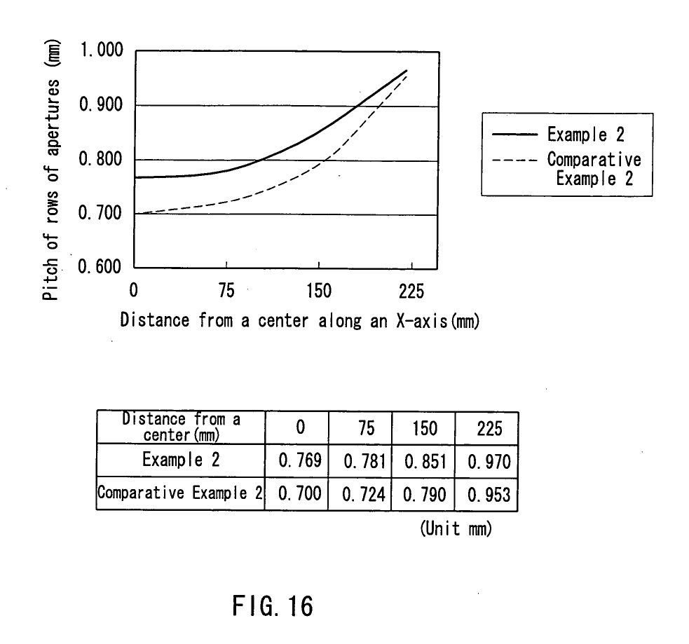

FIG. 16 shows changes along the X-axis in the X-axis direction pitch of rows of apertures adjacent in the X-axis direction of the shadow mask 7 in the color picture tube according to Example 2. “Comparative Example 2” shows changes in the X-axis direction pitch of rows of apertures in the shadow mask of a conventional color picture tube in which the perforated region 71 has a spherical surface having a single radius of curvature. A lower column in FIG. 16 shows numerical values of a pitch of rows of apertures at main portions on the X-axis.

The electron beam movement amount and the electron beam intrusion amount with respect to an adjacent phosphor in the color picture tubes of Example 2 and Comparative Example 2 are shown together in the above-mentioned Table 2.

In Example 2, the movement amount L_{D} of the landing position of an electron beam during the occurrence of doming is 57% of that of Comparative Example 2, while the electron beam intrusion amount D_{P} with respect to an adjacent phosphor is 38% of that of Comparative Example 2. It is understood that the color purity is unlikely to be degraded even if the landing positional shift of electron beams occurs due to doming in the same way as in Example 1.

The applicable field of the present invention is not particularly limited, and the present invention is applicable in a wide range to a color picture tube, for example, in a TV or a computer display.

The embodiments as described above are all intended to clarify the technical contents of the present invention. The present invention can be modified variously in the scope of the spirit of the present invention and claims without being limited to only such specific examples, and should be interpreted broadly.

What is claimed is:

1. A color picture tube comprising a panel in which a phosphor screen is formed on an inner surface of a substantially rectangular useful portion, and a shadow mask,
wherein the phosphor screen is composed of a black non-light-emitting layer and a phosphor formed in a region where the black non-light-emitting layer is not formed,
the shadow mask includes a substantially rectangular perforated region opposed to the phosphor screen, in which a number of electron beam passage apertures are arranged in vertical and horizontal directions,
a radius of curvature of an outer surface of the useful portion of the panel is 10,000 mm or more,
assuming that a tube axis is a Z-axis, an axis orthogonal to the Z-axis and parallel to a long side direction of the useful portion is an X-axis, an axis orthogonal to the Z-axis and parallel to a short side direction of the useful portion is a Y-axis, a distance (unit: mm) along the X-axis between a point where the X-axis and a peripheral edge of the useful portion cross each other and a center of the useful portion is LH, and a total number of rows of apertures composed of the electron beam passage apertures arranged on a straight line substantially parallel to the Y-axis is N, the following expression:
0.9≦LH/N≦1.0
is satisfied,
assuming that a pitch of the rows of apertures adjacent to each other is PHC at a center of the perforated region, PHH at a major axis end where the X-axis and a peripheral edge of the perforated region cross each other, and PHM at a point away from the center of the perforated region by ⅔ of a distance MH between the center of the perforated region and the major axis end along the X-axis, the following expressions:
PHM/PHC≦1.2
PHH/PHC≦1.4
are satisfied, and
the shadow mask is made of a material containing 95% or more of iron.

2. The color picture tube according to claim 1, wherein assuming that an aperture width in the X-axis direction of the electron beam passage apertures is DC at the center of the perforated region, DH at the major axis end, and DM at a point away from the center of the perforated region by (⅔)×MH along the X-axis, the following expressions:
DH/PHM≦0.24
DH/PHH≦0.25
are satisfied.

3. The color picture tube according to claim 1, wherein assuming that an area ratio of the black non-light-emitting layer per unit area in the useful portion of the phosphor screen is BRC at the center of the useful portion, BRH at the major axis end where the X-axis and the peripheral edge of the useful portion cross each other, and BRD at a diagonal axis end where a diagonal axis and the peripheral edge of the useful portion cross each other, the following expression:
BRD≦BRC≦BRH
is satisfied.

4. The color picture tube according to claim 1, wherein assuming that a thickness of the panel is T_{C} at the center of the useful portion of the phosphor screen, T_{H} at the major axis end where the X-axis and the peripheral edge of the useful portion cross each other, T_{M} at a point away from the center of the useful portion by (⅔)×LH along the X-axis, and T_{L} at a point where a plane including the point away from the center of the useful portion by (⅔)×LH along the X-axis and being parallel to a YZ-plane crosses the peripheral edge of the useful portion, the following expressions:
T_{H}/T_{C}≦1.3
1.6≦T_{L}/T_{M}≦1.9
are satisfied, and
a transmittance at the center of the useful portion of the panel is 40 to 60%.
